(19) United States
(12) Patent Application Publication
(10) Pub. No.: US 2010/0253864 A1
(43) Pub. Date: Oct. 7, 2010

(54) DIGITAL PHOTO FRAME

(75) Inventors: Nobuhiro Fujinawa, Yokohama-shi (JP); Seiji Takano, Yokohama-shi (JP); Kazue Minagawa, Kawasaki-shi (JP)

Correspondence Address: OLIFF & BERRIDGE, PLC, P.O. BOX 320850, ALEXANDRIA, VA, 22320-4850, US

(73) Assignee: NIKON CORPORATION, Tokyo (JP)

(21) Appl. No.: 12/748,936

(22) Filed: Mar. 29, 2010

(30) Foreign Application Priority Data
Apr. 3, 2009 (JP) 2009-091332

(51) Int. Cl. H04N 5/66

(52) U.S. Cl. 348/839; 348/E05.133

(57) ABSTRACT

A digital photo frame enabling video to be viewed not only in a stationary state but also when carried in the hand of the viewer, that is, a digital photo frame having a display for displaying an image, a detector detecting if the frame is carried on a cradle or is detached from the cradle, and an output controller setting different output modes of the video in accordance with the results of detection of the detector.

### CROSS-REFERENCE TO RELATED APPLICATION

The disclosure of the following priority application is herein incorporated by reference: Japanese Patent Application No. 2009-091332 filed on Apr. 3, 2009.

### TECHNICAL FIELD

The present invention relates to a digital photo frame.

### BACKGROUND ART

Known in the art is a digital photo frame reading out image data stored in a memory card and displaying it on a display (for example, see Japanese Patent Laid-open Publication (A) No. 2001-67004). In this digital photo frame, the image displayed on the display is rotated in accordance with the posture when attaching the digital photo frame to a stand, that is, a vertical posture or horizontal posture.

### CITATION LIST

### Patent Literature

Japanese Patent Laid-open Publication (A) No. 2001-67004

### SUMMARY OF INVENTION

### Technical Problem

In this digital photo frame, use in the stationary state attached to the stand is assumed, but digital photo frames enabling images etc. to be viewed even in the state held in the hand of the viewer are also being sought.

An object of the present invention is to provide a digital photo frame enabling viewing of video not only in the stationary state, but also held in the hand of the viewer.

### Solution to Problem

The digital photo frame of the present invention is a digital photo frame having a display for displaying an image and outputting video, comprising a detector for detecting if the frame is carried on a cradle or is detached from the cradle and an output controller setting different output modes of the video in accordance with the results of detection by the detector.

Further, the digital photo frame of the present invention is a digital photo frame having a display for displaying an image and outputting video, comprising a detector for detecting if the frame is carried on a cradle or is detached from the cradle and a communication controller acquiring the video from an external device when the frame is detached from the cradle.

### ADVANTAGEOUS EFFECTS OF INVENTION

Summarizing the advantageous effects of the invention, according to the digital photo frame of the present invention, it is possible to view a video not only in the stationary state, but also held in the hand of the viewer.

### BRIEF DESCRIPTION OF DRAWINGS

FIG. 1 is a perspective view of the appearance of a digital photo frame according to an embodiment of the present invention.

FIG. 2 is a block diagram of the system configuration of a digital photo frame according to an embodiment of the present invention.

FIG. 3 is a flowchart of the processing when a digital photo frame according to an embodiment of the present invention is detached from its cradle.

### DESCRIPTION OF EMBODIMENTS

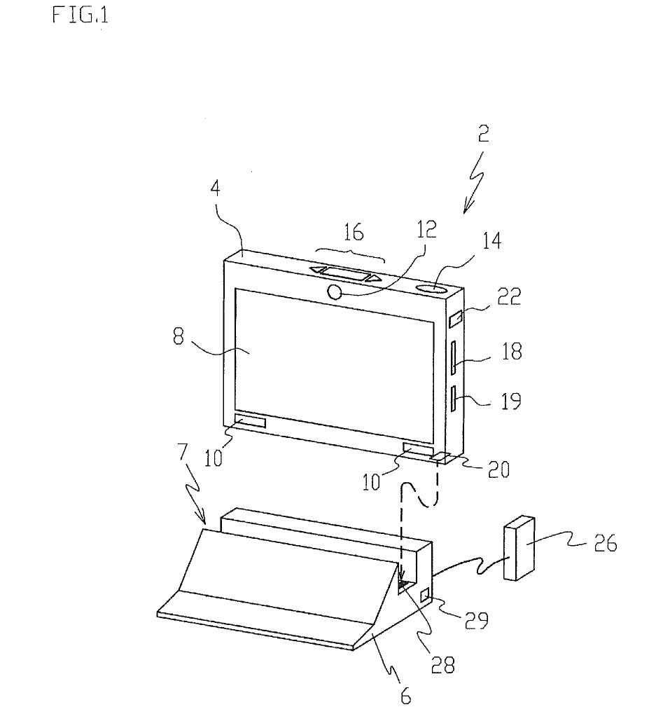

Below, referring to the drawings, a digital photo frame of an embodiment of the present invention (hereinafter referred to as a “DPF”) will be explained. Note that, in the present embodiment, “video” shall be deemed to include not only an image, but also audio and to include not only moving pictures, but also for example combinations of images and messages or other audio or music corresponding to those images. FIG. 1 is a perspective view of the appearance of a DPF and cradle according to an embodiment. The frame body 4 of the DPF 2 can be carried on the cradle 6 in a freely detachable manner. Further, the DPF 2 may be carried in a horizontal posture where the bottom of the frame body 4 in FIG. 1 is brought into contact with the cradle 6 and a vertical posture where a side surface of the frame body 4 is brought into contact with the cradle 6. Note that, FIG. 1 shows the state where the frame body 4 is detached from the cradle 6.

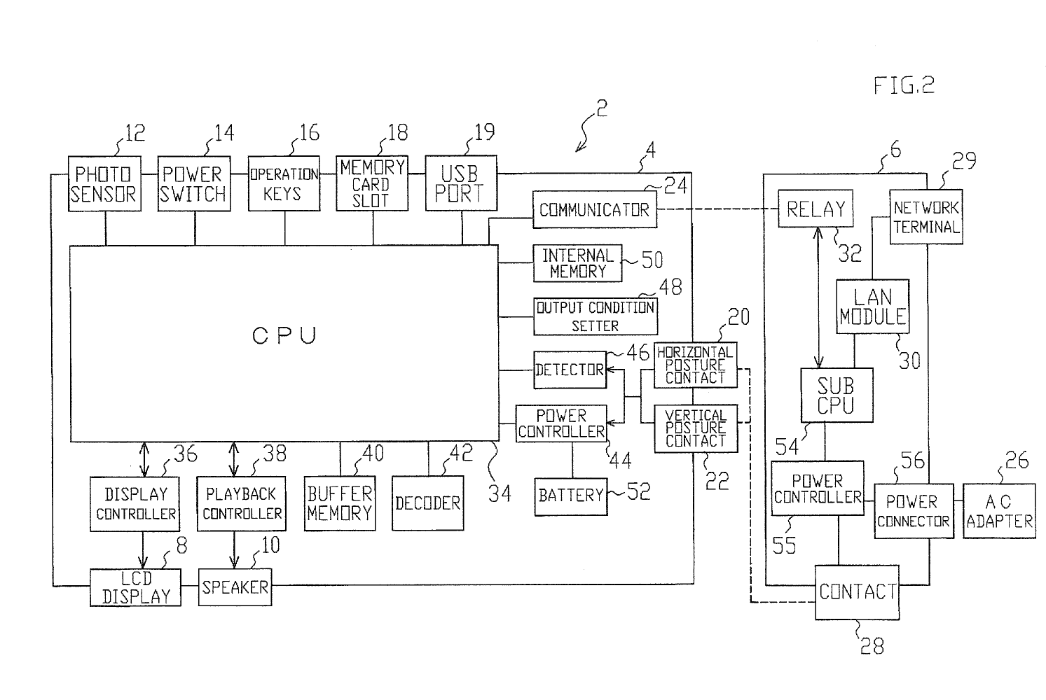

At the side surface of the frame body 4, an LCD display 8 for electrically displaying an image or time or other information, a speaker 10 for outputting music or other audio, and a photo sensor 12 for detecting the outside brightness are provided. At the top surface, a power switch 14 for switching the power of the DPF 2 on/off and operating keys 16 used when setting the functions of the DPF 2 or setting the display mode of the LCD display 8 are provided. Further, at the side surface of the frame body 4, a memory card slot 18 for inserting a memory card in which images, music, or other data are stored and a USB port 19 to which a USB device may be connected are provided. Further, a horizontal posture contact 20 for connection with a later explained contact 28 of the cradle 6 and receiving the supply of power is provided at the bottom surface of the frame body 4, and a vertical posture contact 22 is provided at a side surface of the frame body 4. Further, the frame body 4 houses a communicator 24 (see FIG. 2) for sending and receiving images, music, and other data through the cradle 6.

The cradle 6 is provided with a mount 7 for carrying the frame body 4. Further, the cradle 6 is connected to an AC adapter 26 able to obtain power from an external commercial power supply and feed power through the contact 28 provided in the mount 7 to the frame body 4. Further, the cradle 6 is provided with a network terminal 29 to which a LAN cable is connected. In the cradle 6, a LAN module 30 (see FIG. 2) for LAN communication by a cable through the network terminal 29 or wireless LAN communication through a wireless LAN access point and a relay 32 (see FIG. 2) for relay between the LAN module 30 and a communicator 24 provided in the frame body 4.

FIG. 2 is a block diagram showing the system configuration of the DPF according to the embodiments. The frame body 4 is provided with a CPU 34. The CPU 34 is connected to a display controller 36 controlling the image or information to be displayed on the LCD display 8, the display luminance, color and tone, etc. of the displayed image etc., a playback controller 38 playing back music or other audio to be output from the speakers 10, a buffer memory 40 temporarily storing video output from the display controller 36 or playback controller 38, a decoder 42 including a JPEG decoder decompressing image data compressed by the JPEG scheme to enable playback and an MPEG decoder decompressing moving image (video) data compressed by the MPEG scheme to enable playback, etc., a power controller 44 receiving power through the horizontal position contact 20 or vertical position contact 22 from the cradle 6 and controlling the power of the frame body 4, a detector 46 detecting through the horizontal position contact 20 and vertical position contact 22 if the frame body 4 is set at the cradle 6 or is detached from the cradle 6, an output condition setter 48 setting output conditions of the video input by the operating keys 16, an internal memory 50 storing images, music, or other data including information images showing settings of functions of the DPF 2 and the time and date, photo sensor 12, power switch 14, operating keys 16, memory card slot 18, USB port 19, and communicator 24.

Further, the power controller 44 is connected to a battery 52 feeding power to the frame body 4 through the CPU 34 when the frame body 4 is detached from the cradle 6. Note that, when the frame body 4 is carried in the cradle 6, in addition to feeding power from the cradle 6 through the CPU 34 to the frame body 4, it is also possible to charge the battery 52.

Further, the cradle 6 is provided with a sub CPU 54. The sub CPU 54 is connected to a LAN module 30, relay 32, and power controller 55 feeding power. The LAN module 30 is connected to a network terminal 29. Further, the cradle 6 is provided with a contact 28 and is connected through the power controller 55 and power connector 56 to an AC adapter 26.

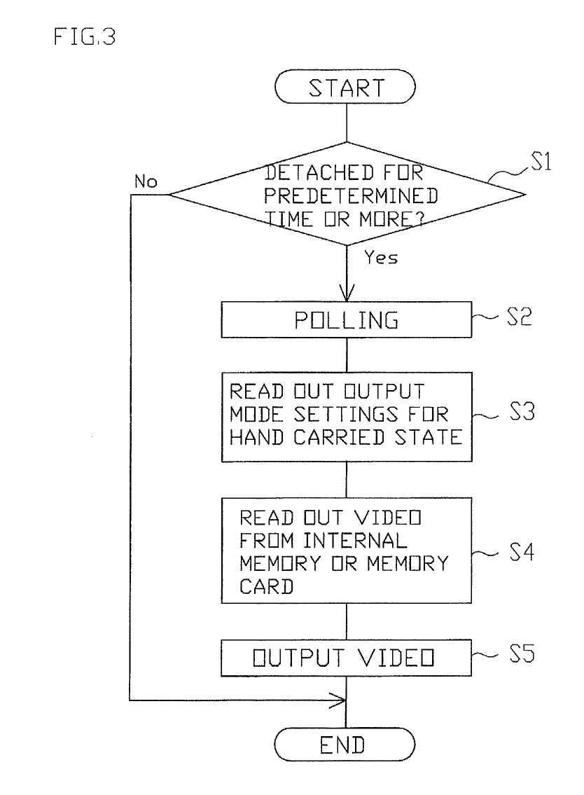

Next, referring to the flowchart shown in FIG. 3, the processing when the DPF according to the embodiment is detached from the cradle will be explained. In the present embodiment, an output mode of the video and other operations for when the frame body 4 is carried in the cradle 6 (stationary state) and the output mode of the video and other operations for when the frame body 4 is detached from the cradle 6 (hand held state) may be set using the operating keys 16 etc. at the output condition setter 48. Therefore, in the stationary state and in the hand held state, the display controller 36 and the playback controller 38 can set as video output modes for example different display modes, display luminances, colors and tones, audio outputs, and output restrictions. Output control corresponding to the stationary state and hand held state becomes possible.

When the frame body 4 is detached from the cradle 6 in the stationary state, the detector 46 detects that it has been detached from the cradle 6 and it is determined if for example 5 seconds or another predetermined time or more has elapsed from detachment (step S1). If the predetermined time has not elapsed and the frame body 4 is carried on the cradle 6 (step S1: No), it is determined that the posture has been changed from a horizontal posture to a vertical posture for example and the processing is ended.

On the other hand, when the predetermined time has elapsed (step S1: Yes), a polling operation is performed (step S2). That is, it is confirmed through the communicator 24 and cradle 6 if the network server or other external device has stored new or updated video data or other newly arriving content. If storing it, the newly arriving content is downloaded through the LAN module 30 and relay 32 and stored in the internal memory 50 or memory card inserted in the memory card slot 18. Note that, in addition to the polling performed at the processing shown at step S2, it is also possible to perform polling, even in the case carried in the cradle 6 once a day etc. for example, at a predetermined time late at night. When in the state carried on the cradle 6 and newly arriving content is downloaded, the LCD display 8 may display an icon to that effect or otherwise report the event. Next, the settings of the output modes in the hand held state are read out from the output condition setter 48 and output control by the output modes corresponding to the hand held state, that is, output control by output modes different from the stationary state, is performed (step S3).

Here, the differing output modes between the stationary state and hand held state will be explained.

Regarding the display modes, different outputs modes may be set by, in the stationary state, setting a fixed display mode in which the display controller 36 outputs an image for display at the LCD display 8 for example for one hour or one day or another long period for one image and, in the hand held state, setting a slide show mode in which it switches images in times of less than several minutes so. Alternatively, different display modes may be set by, in the stationary state, setting the above-mentioned fixed display mode and in the hand held state, setting a thumbnail display mode in which a plurality of images are output to one screen reduced in size. Further, when the slide show mode is set for both of the stationary state and hand held state, the image switching speed may be set differently. Alternatively, different output modes may be set by, when shifting from the stationary state to hand held state, repeating the slide show from several images before or another predetermined number of images.

Further, different output modes may be set by adding the date, time, and other information to the display in the stationary state and not displaying that information in the hand held state. When displaying that information, it may be displayed full screen or may be displayed reduced in size at part of the screen.

Further, regarding the audio output, different output modes may be set by, under the control of the playback controller 38, not outputting the audio output from the speaker 10 in the stationary state and outputting the audio in the hand held state. Note that, it is also possible to output audio regardless of if the frame is in the stationary state or in the hand held state. In this case, it is also possible to make the volume in the stationary state greater than the volume in the hand held state or otherwise make the volumes of the audio output in the stationary state and hand held state different.

Further, regarding the restrictions on video output to the LCD display 8, different output modes may be set by, in the stationary state, displaying images which can be displayed only in the stationary state and images which can be displayed regardless of whether the frame is in the stationary state or hand held state, while in the hand held state, outputting images which can be displayed only in the hand held state and images which can be displayed regardless of whether the frame is in the stationary state or hand held state. Note that, in this case, the images stored in the internal memory 50 or memory card inserted in the memory card slot 18 may be set as images able to be displayed only in the stationary state, images able to be displayed only in the hand held state, and images which can be displayed in both states.

Further, when the viewing time in the hand held state is for example about one week before or after a birthday, wedding anniversary, or other set date, it is also possible to output images in a specific image display mode displaying images taken around the birthdays or wedding anniversaries of previous years. Further, different display modes may be set by outputting images in the hand held state in a new content priority display mode displaying unchecked content on a priority basis when new or updated video data or other content acquired from a network server or other external device has not yet been opened.

Further, regarding the display luminance of the LCD display 8, different output modes may be set by the display controller 36 changing the display luminance of the LCD display 8 in the stationary state whenever necessary in accordance with the outside brightness measured by the photo sensor 12 and fixing the display luminance regardless of the outside brightness in the hand held state since the outside brightness is liable to frequently change depending on the angle when hand held.

Further, regarding the color and tone of the image displayed on the LCD display 8, different output modes may be set by the display controller 36 controlling the frame to set a color intensity higher and raise the contrast in the stationary state considering the case of viewing from a longer distance and not controlling it to display a higher color intensity and contrast in the hand held state since the image may be viewed close up.

Further, the video data is read out from the memory card inserted in the memory card slot 18 or the internal memory 50 (step S4) and the video is output in accordance with the set output modes by the display controller 36 and playback controller 38 (step S5).

The video or other output is continued until the frame body 4 is placed on the cradle 6. When the frame body 4 placed on the cradle 6 is detected by the detector 46, the operation settings for when the frame body 4 is carried on the cradle 6 set by the output condition setter 48 are read out. Here, for the operation settings when the frame body 4 is carried on the cradle 6 as well, a reset mode displaying the image which had been displayed when the frame body 4 was detached from the cradle 6 or a continued operation mode where the image which had been displayed when the frame body 4 was placed on the cradle 6 may be set. Furthermore, a standby mode reducing the amount of power supplied from the power controller 44 may also be set.

When the read out operation settings are the reset mode or continued operation mode, video data is read out from the internal memory 50 or memory card inserted in the memory card slot 18 in accordance with the settings and the video etc. is output under the control of the display controller 36 and playback controller 38 from the LCD display 8 and speaker 10.

Further, when the read out settings are the standby mode, the amount of power fed from the power controller 44 is reduced and the standby state is set. Note that, when set in the standby state, it is also possible to continue to display an image but reduce the display luminance of the LCD display 8 by the display controller 36 or stop the output of the image to the LCD display 8 by the display controller 36.

According to the DPF according to the present embodiment, video can be viewed in not only the stationary state, but also with the frame held in the hand of the viewer, so the frame is user friendly.

Note that, in the above embodiment, the video output modes were explained with reference to the examples of display luminance, color and tone, audio output, display mode, and video output restrictions, but when changing the output modes, it is sufficient to change one or more of these output modes. Further, in the above embodiment, it is possible to mount the cradle onto the wall. In this case, it is possible to use the DPF 2 in the wall hanging state (in the stationary state) by placing the DPF 2 onto the cradle 6 mounted on the wall or it is possible to use the DPF 2 in the hand held state by detaching the DPF 2 from the cradle 6.

Further, in the above embodiment, a polling operation and processing for setting different video output modes were performed, but it is also possible to perform just one of the two.

Further, in the above embodiment, the display luminance, color and tone, audio output, display modes, video output restrictions, and operations when placed on the cradle were set, but it is also possible to use default settings or other settings stored in advance for these settings.

Further, in the above embodiment, when setting different display modes, the explanation was given of the example of setting a fixed display mode in the stationary state and a slide show mode in the hand held state, but it is also possible to set the slide show mode in the stationary state and the fixed display mode in the hand held state.

Further, in the above embodiment, video data etc. was read out from a memory card inserted in the memory card slot or the internal memory, but it is also possible to read out video data from a USB device connected to the USB port.

Further, in the above embodiment, it is also possible to set a standby state reducing the amount of power supplied from the power controller 44 when the frame is not operated for a constant time or more in the stationary state or hand held state. In this case, it is possible to keep down the power consumption and possible to extend the battery life in the hand held state.

Further, in the above embodiment, the detector 46 was used to detect through the horizontal position contact 20 and vertical position contact 22 whether the frame body 4 is carried on the cradle 6 or is detached from the cradle 6, but it is also possible to detect if the frame body 4 is carried on the cradle 6 or is detached from the cradle 6 by determining if power is being supplied through the power controller 44.

Further, in the above embodiment, polling was conducted with the cradle 6 by wireless communication, that is, through the cradle, but when the frame body 4 can communicate with the access point of a wireless LAN, it is also possible to directly acquire video data from the access point.

Further, in the above embodiment, when setting different display modes of the images, when setting the fixed display mode in the stationary state and the slide show mode in the hand held state, it is also possible to conduct a slide show of images stored in the same folder in the internal memory or memory card as the image which had been displayed in the fixed display mode or other images belonging to the same group.

The embodiments described hereinabove have been presented for easy understanding of the invention and are not intended to limit the invention. Accordingly, the respective elements disclosed in the foregoing embodiments shall be construed to cover all design modifications and equivalents that fall within the technical scope of the invention.

1. A digital photo frame having a display for displaying an image and outputting video, comprising
a detector for detecting if the frame is carried on a cradle or is detached from the cradle and
an output controller setting different output modes of the video in accordance with the results of detection by the detector.

2. The digital photo frame as set forth in claim 1, wherein the output controller sets different switching speeds of the image to be displayed on the display when carried on the cradle and when detached from the cradle.

3. The digital photo frame as set forth in claim 1, wherein
the frame is further comprised with a photo sensor for measuring an outside brightness, and
the output controller sets different modes of change of display luminance of the display based on the outside brightness when carried on the cradle and when detached from the cradle.

4. The digital photo frame as set forth in claim 1, wherein
the output controller displays the image on the display together with additional information when carried on the cradle and displays the image on the display without the information when detached from the cradle.

5. The digital photo frame as set forth in claim 1, wherein
the frame has a speaker for outputting audio, and
the output controller does not output the audio from the speaker when carried on the cradle and outputs the audio from the speaker when detached from the cradle.

6. The digital photo frame as set forth in claim 1, wherein
the frame has a speaker for outputting audio, and
the output controller sets different volumes of the audio output from the speaker when carried on the cradle and when detached from the cradle.

7. The digital photo frame as set forth in claim 1, wherein
the output controller sets different colors or tones of the image display on the display when carried on the cradle and when detached from the cradle.

8. The digital photo frame as set forth in claim 1, further comprising
a display restriction setter setting video which can be output only when the frame is carried on the cradle, video which can be output only when the frame is detached from the cradle, and video which can be output regardless of the state of mounting on the cradle.

9. The digital photo frame as set forth in claim 1, wherein
the output controller performs a fixed display outputting one the image to the display for a constant time or more when the frame is carried on the cradle and performs a slide show outputting a plurality of the images to the display switched at predetermined times when the frame is detached from the cradle.

10. The digital photo frame as set forth in claim 1, wherein
the output controller performs a slide show outputting a plurality of the images to the display switched at predetermined times when the frame is carried on the cradle and repeats the slide show from a predetermined number of the images back when the frame is detached from the cradle.

11. The digital photo frame as set forth in claim 1, wherein
the output controller performs a fixed display outputting one the image to the display for a constant time or more when the frame is carried on the cradle and performs a thumbnail display outputting a plurality of the images to the display reduced to a predetermined size when the frame is detached from the cradle.

12. The digital photo frame as set forth in claim 1, wherein
the output controller performs a slide show outputting a plurality of images to the display switched by a predetermined speed when the frame is carried on the cradle and performs a fixed display outputting one the image to the display when the frame is detached from the cradle.

13. The digital photo frame as set forth in claim 1, wherein
the frame is further comprised with a video acquirer acquiring the video from an external device, and
the output controller acquires the video through the video acquirer when the frame is carried on the cradle and outputs the acquired video when the frame is detached from the cradle.

14. The digital photo frame as set forth in claim 1, wherein
the output controller makes the image displayed at the display when the frame is placed on the cradle the image which had been displayed when the frame was detached from the cradle.

15. The digital photo frame as set forth in claim 1, further comprising
a reset operation setter setting whether to display the image which had been displayed when the frame was detached from the cradle at the display when the frame is placed at the cradle.

16. The digital photo frame as set forth in claim 1, further comprising
an operation setter for setting an operation when the detector detects a change in a state of mounting on the cradle.

17. The digital photo frame as set forth in claim 1, further comprising
a power controller setting a standby state reducing the amount of supply of power when the frame is carried on the cradle.

18. The digital photo frame as set forth in claim 1, wherein
the frame is further comprised with a specific image setter setting a plurality of the images by predetermined conditions, and
the output controller performs a slide show displaying a plurality of the images set by the specific image setter on the display switched at predetermined times when the frame is detached from the cradle.

19. The digital photo frame having a display for displaying an image and outputting video, comprising
a detector for detecting if the frame is carried on a cradle or is detached from the cradle and
a video acquirer for acquiring the video from an external device when the frame is detached from the cradle.
